(19) United States
(12) Patent Application Publication
(10) Pub. No.: US 2026/0236298 A1
(43) Pub. Date: Aug. 13, 2026

(54) DISPLAY DEVICE AND METHOD FOLLOWING SELECTIVE CPU SCHEDULING POLICY

(71) Applicant: SAMSUNG ELECTRONICS CO., LTD., Suwon-si (KR)

(72) Inventors: Kyungmin KANG, Suwon-si (KR); Jihoon KIM, Suwon-si (KR); Iksoon KIM, Suwon-si (KR); Youngho CHOI, Suwon-si (KR); Changhyeon CHAE, Suwon-si (KR); Chulmok LEE, Suwon-si (KR); Youngjin KIM, Suwon-si (KR)

(21) Appl. No.: 19/553,737

(22) Filed: Mar. 2, 2026

Related U.S. Application Data
(63) Continuation of application No. PCT/KR2026/002530, filed on Feb. 11, 2026.

(30) Foreign Application Priority Data
Feb. 11, 2025 (KR) 10-2025-0017327

(51) Int. Cl. G06F 9/48; G06F 9/50

(52) U.S. Cl. CPC G06F 9/4881; G06F 9/5038

(57) ABSTRACT

The disclosure provides a display device following a selective CPU scheduling policy. The display device may, in response to a first resource request occurring from the first process while a first process outputs a screen through the display, identify whether the first resource is in use, and based on determining that the first resource is being used by a second process and that a CPU scheduling priority of the first process is higher than a CPU scheduling priority of the second process, adjust the CPU scheduling priority of the second process to be higher than or equal to the CPU scheduling priority of the first process, and in response to the first resource being released by the second process, restore the CPU scheduling priority of the second process to an original CPU scheduling priority.

### CROSS-REFERENCE TO RELATED APPLICATIONS

This application is a continuation of International Application No. PCT/KR2026/002530 designating the United States, filed on Feb. 11, 2026, in the Korean Intellectual Property Receiving Office and claiming priority to Korean Patent Application No. 10-2025-0017327, filed on Feb. 11, 2025, in the Korean Intellectual Property Office, the disclosures of each of which are incorporated by reference herein in their entireties.

### BACKGROUND

### Field

The disclosure relates to a display device and method following a selective CPU scheduling policy.

### Description of Related Art

In the past, a pay TV service that displayed a broadcast screen when the TV was turned on was common, but recently, a cord-cutting phenomenon where consumers move to new platforms such as online streaming services is increasing. A transition to over the top (OTT) services is taking place, replacing Pay TV and allowing users to select and watch content when they want. Accordingly, consumer usage patterns have also changed to a usage pattern where OTT services start immediately when the TV is turned on without turning on the TV and changing channels.

As applications (e.g., web applications) that may be executed on TVs become increasingly diverse, scenarios of using multiple apps simultaneously while switching between them are increasing. For example, scenarios may occur such as switching to a TV plus app while watching a video in an A OTT app, or executing a B OTT app while playing a home screen picture-in-graphic (PIG) video. However, if the response time to an app execution or switching request is not consistent, the user experience may deteriorate.

The above-described information may be provided as related art for the purpose of helping understanding of the disclosure. No assertion or determination is made as to whether any of the foregoing is applicable as background art in relation to the disclosure.

### SUMMARY

A display device according to an example embodiment of the disclosure may include: a display, a memory including at least one storage medium storing instructions, and at least one processor, comprising processing circuitry, wherein at least one processor, individually and/or collectively, may be configured to execute the instructions and to cause the display device to: in response to a first resource request occurring from a first process while the first process outputs a screen through the display, identifying whether the first resource is in use; based on determining that the first resource is being used by a second process and that a CPU scheduling priority of the first process is higher than a CPU scheduling priority of the second process, adjusting the CPU scheduling priority of the second process to be higher than or equal to the CPU scheduling priority of the first process; and in response to the first resource being released by the second process, restoring the CPU scheduling priority of the second process to an original CPU scheduling priority.

A method of operating a display device according to an example embodiment of the disclosure may include: in response to a first resource request occurring from a first process while the first process outputs a screen through a display, identifying whether the first resource is in use; based on determining that the first resource is being used by a second process and that a CPU scheduling priority of the first process is higher than a CPU scheduling priority of the second process, adjusting the CPU scheduling priority of the second process to be higher than or equal to the CPU scheduling priority of the first process; and in response to the first resource being released by the second process, restoring the CPU scheduling priority of the second process to an original CPU scheduling priority.

According to an example embodiment of the disclosure, a non-transitory computer-readable storage medium storing at least one computer-readable instruction may be provided. The at least one instruction may, when executed by at least one processor, comprising processing circuitry, of a display device, individually and/or collectively, cause the display device to perform at least one operation comprising: in response to a first resource request occurring from a first process while the first process outputs a screen through a display, identifying whether the first resource is in use; based on determining that the first resource is being used by a second process and that a CPU scheduling priority of the first process is higher than a CPU scheduling priority of the second process, adjusting the CPU scheduling priority of the second process to be higher than or equal to the CPU scheduling priority of the first process; and in response to the first resource being released by the second process, restoring the CPU scheduling priority of the second process to an original CPU scheduling priority.

### BRIEF DESCRIPTION OF THE DRAWINGS

The above and other aspects, features and advantages of certain embodiment of the present disclosure will be more apparent from the following detailed description, taken in conjunction with the accompanying drawings, in which:

FIG. 1 is a diagram the visibility state of an app in a display device.

FIG. 2 is a diagram illustrating an example of the state of processes and resource usage state in a display device.

FIG. 3 is a diagram illustrating an example of a CPU scheduling policy of a display device according to various embodiments.

FIG. 4 is a resource allocation graph illustrating an example process according to a CPU scheduling policy according to various embodiments.

FIG. 5 is a system architecture diagram for CPU scheduling of a display device according to various embodiments.

FIG. 6 is a flowchart illustrating an example selective CPU scheduling priority adjustment operation of a display device according to various embodiments.

FIG. 7 is a diagram illustrating an example of resource allocation information in a display device according to various embodiments.

FIG. 8 is a flowchart illustrating an example resource release request operation of a display device according to various embodiments.

FIG. 9 is a block diagram illustrating an example configuration of a display device according to various embodiments.

Reference may be made to the accompanying drawings in the following description, and specific examples that may be practiced are shown as examples within the drawings. Other examples may be utilized and structural changes may be made without departing from the scope of the disclosure.

### DETAILED DESCRIPTION

Hereinafter, various example embodiments of the disclosure are described in greater detail with reference to the drawings. However, the disclosure may be implemented in other various forms and is not limited to the various embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

Hereinafter, various example embodiments of the disclosure are described in greater detail with reference to the accompanying drawings.

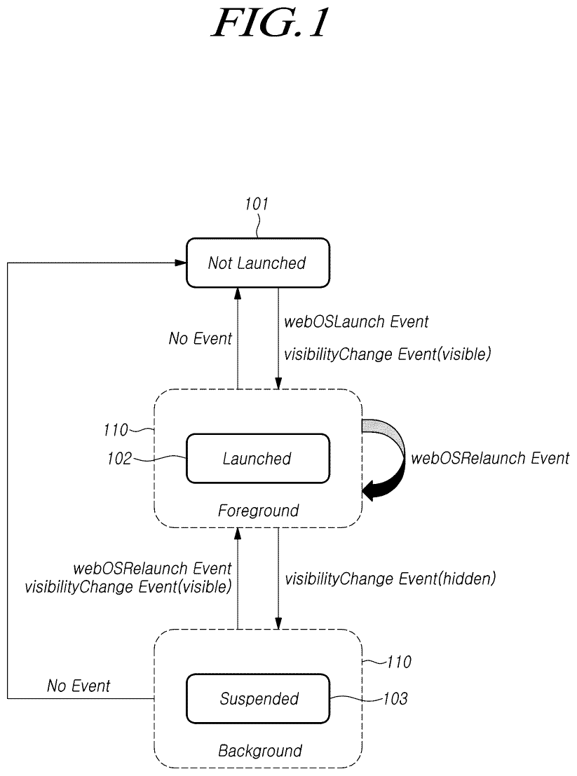

FIG. 1 is a diagram illustrating an example visibility state of an app in a display device.

A display device according to an embodiment may allocate CPU resources according to the visibility state of each running application (hereinafter referred to as ‘app’ for convenience of description). An app may be launched, suspended, or terminated according to a user interaction or a system event occurrence. Each app may be either in a foreground state visible to the user, or in a background state invisible to the user while running.

Referring to FIG. 1, initially an app may be in a not launched state 101. An app may be launched 102 by a user input or a system event. In this case, the running app enters a foreground state 110, and an execution screen may be displayed through the display. An app may be suspended 103 during execution. In this case, the suspended app enters a background state 120, and the execution screen is not displayed and may not be exposed to the user.

The exposure of an app in use may change according to an event occurrence. For example, an app may enter a background state 120 and not visible to the user due to a visibilityChange Event(hidden) occurrence. An app may enter a foreground state 110 and visible to the user due to a visibilityChange Event(visible) occurrence.

A running app may be terminated by a system event (e.g., No Event) in case that no event occurs for a predetermined (e.g., specified) period of time.

In an embodiment, the display device may apply a CPU scheduling priority policy so that an app visible to the user may be processed with the highest priority. The display device may allocate a high CPU scheduling priority to an app in the foreground state 110 to enable immediate request processing. The display device may allocate a low CPU scheduling priority to an app in the background state 120, allowing execution but with a relatively low CPU scheduling priority allocated, and may wait until CPU resources are allocated. The foreground state 110 and the background state 120 are determined based on exposure, and an event listener may identify the exposure state information of each app. The display device may set the CPU usage priority of the app to the highest in response to entering the foreground state 110 by an app switch. For example, the display device may receive an execution request for a second app by a user input while a video is being played by a first app. The display device may set the CPU scheduling priority of the second app to the highest so that a screen by the second app may be displayed immediately. The display device may define settings for the foreground state and the background state and the corresponding CPU scheduling priority policy. For example, state settings are possible by setting a type object.

In an embodiment, the display device may apply a CPU scheduling priority policy according to the process state. In order of highest priority, there are: a foreground process having an activity or service directly interacting with the current user, a visible process having an activity or service visible on the current screen but not interacting with the user, a started service process having a service that is not directly displayed on the screen but continues to run, a background process having an activity not visible on the screen or a service not running, and an empty process remaining cached in memory after the life cycle of the app has ended. The CPU scheduling priority is highest in case of being exposed to and interacting with the user, and lowest in case of being not exposed to the user and not running. The display device may differentially apply CPU resource allocation to processes according to the CPU scheduling priority.

As such, the display device may allocate CPU resources according to the life cycle, exposure, and execution status of the app. By giving a high CPU usage priority to an app exposed to and interacting with the user, the usability and performance of the app may be guaranteed. However, in a scenario of switching apps, in case that a high CPU usage priority is given only to the app exposed to the user, a delay may actually occur. In the case of an app switching to the background during an app switch, hardware resources provided by the system were being used in the foreground state until the switch, but in case of switching to the background state, the hardware resources being used should be deallocated, and a low CPU usage priority is given to the app switched to the background state. In a circumstance where CPU resource competition is present, a background app may not be able to operate for a long time. In case that an app switched to the foreground needs to use that resource in a circumstance where resources may not be released for a long time, it waits for resource allocation. As a result, a priority inversion phenomenon occurs where a foreground app with a high CPU usage priority may not operate because it waits for resource release from a background app with a low CPU usage priority.

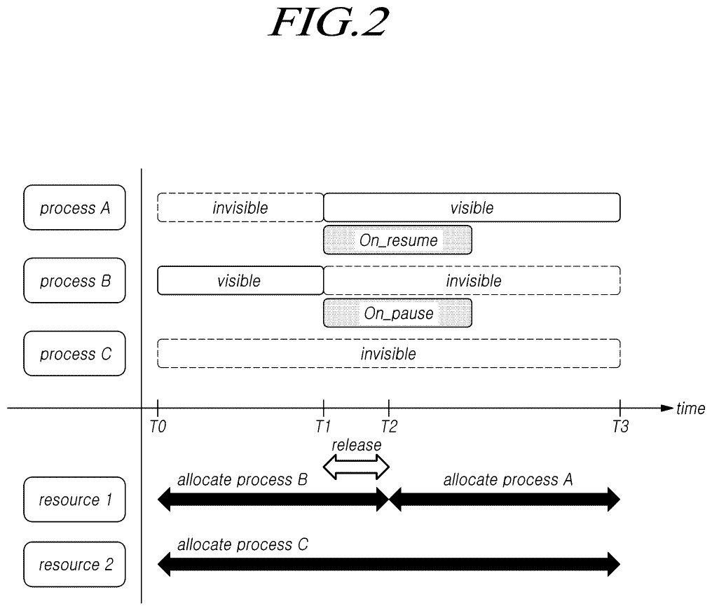

FIG. 2 is a diagram illustrating an example of the state of processes and resource usage state in a display device.

According to an embodiment, hardware resources or software resources may be required in addition to essential CPU resources for executing an app in the display device. For example, an OTT app may use at least one of hardware resources (e.g., HW Decompressor) or software resources (e.g., media decoder) during execution. Hardware or software resources may be shared by multiple processes, and in case that the resource is already in use, other processes may wait to be allocated the resource.

The CPU allocation priority may be determined based on the life cycle of the app. The display device may give a high CPU allocation priority to a foreground app.

Referring to FIG. 2, in case that app A, app B, and app C are started, process A, process B, and process C are executed, respectively. At an initial time T0, process B is running in a visible foreground state, and process A and process C are running in a background state. The display device may give a high CPU usage priority to a process in the foreground state and a low CPU usage priority to a process in the background state. Process B may have a relatively high CPU usage priority, and processes A and C may have a relatively low CPU usage priority. In case that CPU resources are available, processes A and C in the background state may also be allocated CPU resources. In case that CPU resources are competing, the execution of process B is guaranteed, but processes A and C may continue to wait for CPU resources.

At the initial time T0, resource 1 is being allocated to process B, and resource 2 is being allocated to process C. Resource 1 and resource 2 may be hardware or software resources. Hardware/software resources may be allocated at the request of each process separately from CPU resource allocation, and may be released in case that use is completed.

At a first time T1, in case that an app switch occurs due to a user input, etc., the first app is resumed (on resume) and process A enters the foreground state, the second app is paused (on_pause) and process B enters the background state. Process C continues to run in the background state. The display device may give a high CPU scheduling priority to process A and a low CPU scheduling priority to process B according to the app switch. At the first time T1, process A may request resource 1. Although resource 1 is allocated to process B, in case that there is CPU resource competition, a circumstance may occur where process B in the background state may not release resource 1 while waiting for the CPU. Consequently, process A needs resource 1 but since resource 1 is being used by process B, it waits for resource 1 until resource 1 is recovered. As a result, a priority inversion phenomenon occurs where process A in the foreground state with a high CPU scheduling priority may not operate because it waits for resource release from process B in the background state with a low CPU scheduling priority.

Resource 1 may be allocated to process A in the foreground state at a second time T2 after being recovered from process B.

The time between the first time T1 and the second time T2 becomes a deadlock state where process A may not execute because it lacks resource 1, and process B may not execute because the CPU is taken away. This problem may cause performance degradation of the display device itself.

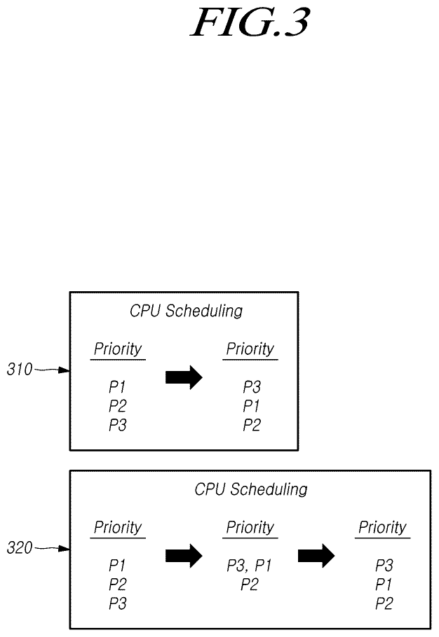

FIG. 3 is a diagram illustrating an example of a CPU scheduling policy of a display device according to various embodiments.

A display device according to an embodiment may basically set the highest CPU scheduling priority for a process in the foreground state, while selectively setting a temporarily high CPU scheduling priority for that process in case that resource contention occurs.

For example, according to a first CPU scheduling policy 310, the display device may give the highest CPU scheduling priority to an app in the foreground state considering the visibility of the app. Referring to FIG. 3, in case that P1 is initially in the foreground state, the CPU scheduling priority may be P1, P2, P3 in order of highest. In case that P3 replaces P1 and switches to the foreground state, the CPU usage priority may be in the order P3, P1, P2. P1 may enter the background state. The first CPU scheduling policy 310 is unrelated to resource allocation, and changes the CPU scheduling priority according to visibility in case of switching apps that occur in multiple apps being used simultaneously. In this case, in case that P1 switches to the invisible background state, it no longer needs to use the hardware/software resources being used, but in a circumstance with CPU competition, it may not be able to release the hardware/software resources it was using because it may not use the CPU.

According to a second CPU scheduling policy 320, the display device sets the CPU scheduling priority based on the visibility of the app like the first CPU scheduling policy 310, but in case that a process in the foreground state corresponds to hardware/software resource contention, it may temporarily adjust the CPU scheduling priority of the process using that resource to be as high as the CPU scheduling priority of the foreground process. Referring to FIG. 3, in case that P1 is initially in the foreground state, the CPU scheduling priority may be P1, P2, P3 in order of highest. In case that P3 switches to the foreground state and P1 switches to the background state due to an app switch, P3 may need a resource allocated to P1. In this case, the display device may adjust the CPU scheduling priority of P1 to be as high as the foreground process for quick recovery of that resource. Accordingly, the CPU scheduling priority may temporarily be equally high for P3 and P1, with the remaining P2 being lower priority. P1 may release the hardware/software resources it was using while its CPU scheduling priority is temporarily adjusted high. In case that P1 releases that resource, the display device may restore the CPU scheduling priority of P1 to the original priority of the background state. Finally, depending on app visibility, the CPU priorities may be ordered from highest to lowest as: P3, P1, P2.

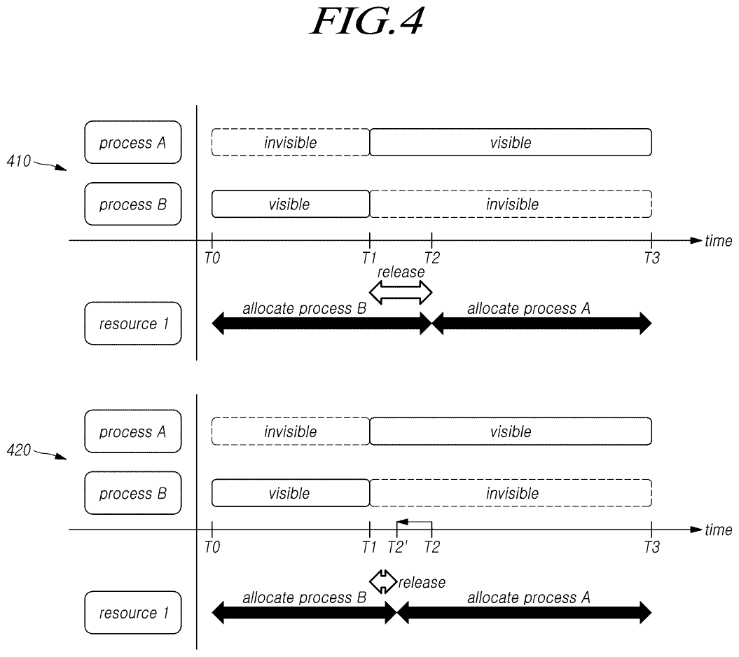

FIG. 4 is a diagram illustrating an example of a resource allocation graph of a process according to a CPU scheduling policy according to various embodiments.

A display device according to an embodiment may apply selective CPU scheduling priority scheduling (e.g., the second CPU scheduling policy 320 of FIG. 3) to consider both the visibility of the app and resource contention.

In a first circumstance 410, at an initial time T0, process B may be in a visible foreground state and using resource 1. At a first time T1, process A may switch to a visible state instead of process B due to a user input or a system event. Process A may be allocated CPU with the highest priority in the foreground state and request resource 1. Since resource 1 is allocated to process B, the display device may not immediately allocate resource 1 in response to the request from process A. The display device may allocate resource 1 to process A at a second time T2 after resource 1 is recovered. From the first time T1 when process A requested resource 1 to the second time T2 when process A is allocated resource 1, a priority inversion phenomenon may occur where process A with a high CPU scheduling priority waits for the resource release operation of process B with a low CPU scheduling priority.

In a second circumstance 420, from the initial time T0 to the first time T1 may be the same as the first circumstance 410. The display device may adjust the CPU scheduling priority of process B to be higher than or equal to the priority of process A for quick resource recovery, even though process B using resource 1 is in the background state, according to the resource 1 request from process A in the foreground state. Process B may release resource 1 at a time T2′ earlier than the second time T2 by being allocated CPU according to the high priority CPU. The priority inversion phenomenon may be minimized or reduced.

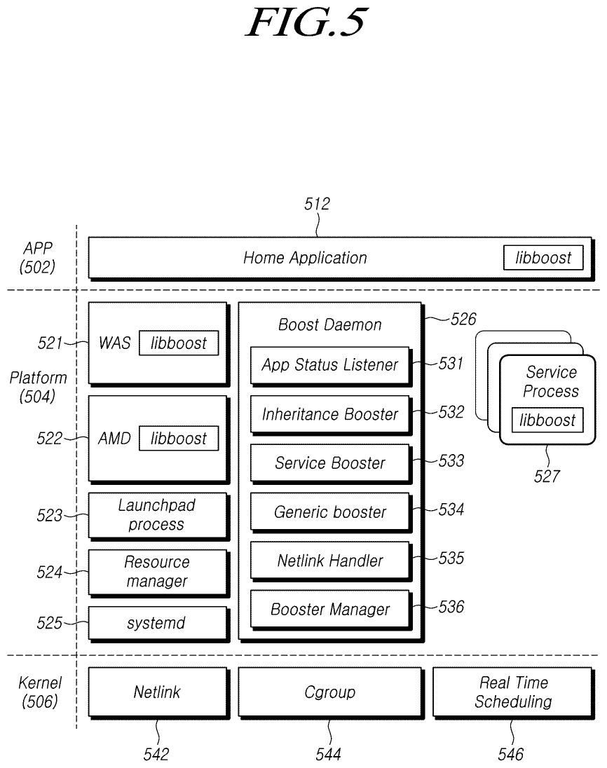

FIG. 5 is an example system architecture diagram for CPU scheduling of a display device according to various embodiments.

A display device according to an embodiment may include a system for CPU scheduling. The system for CPU scheduling may include an application (APP) 502, a platform 504, and a kernel 506.

The application 502 may be referred to as an app (or APP) or may be associated with a service. The application 502 may include a software program executed by the user's selection. According to an example, the application 502 may be executed by a user's selection using at least one external device or a remote control device (e.g., remote control). According to an example, the application 502 may be executed based on an OS and may or may not be displayed on the screen of the display device. The application 502 may provide various services such as media playback. According to an example, the application 502 may include a home application 512 displayed on the screen of the display device after cold booting. According to an example, the home application 512 may be an application providing a UI for at least one of application selection, website search, broadcast channel selection, or external device connection.

The platform 504 may be associated with the OS and may provide an environment for executing application 502. The platform 504 may access hardware through the kernel 506 and may perform control group allocation, control group change or movement, CPU resource allocation, or process management operations associated with services. According to an example, the platform 504 may include a web application service (WAS) 521, an application management daemon (AMD) 522, a Launchpad process 523, a resource manager 524, systemd 525, a boost daemon (or booster module) 526, and a service process (or process) 527.

The WAS 521 may perform an operation for providing a web-based application service. The AMID 522 may manage the execution of the application 502 and the lifecycle of the application 502 (e.g., app create, app resume, app pause, app terminate). The AMD 522 may provide information about the process of the application 502 to the boost daemon 526 in case that an event corresponding to the lifecycle of the application 502 occurs.

The Launchpad process 523 may set an environment for executing or initializing an app. The Launchpad process 523 may provide the initial settings necessary for a running process to operate correctly. The Launchpad process 523 may run in the background and monitor other apps or system processes.

The resource manager 524 may manage registration, removal, request, and release of resources. Resources managed by the resource manager 524 may include hardware resources or software resources. Hardware resources may include, e.g., some of a tuner, demultiplexer, decoder, display engine, network module, storage, audio output device, input device, connection port, or connection interface. Software resources may include, e.g., some of middleware (e.g., broadcast signal processing), operating system resources (e.g., kernel), application resources (e.g., streaming app), data streams and buffers, digital rights management (DRM), contents access system (CAS), or quality of service (QoS). The resource manager 524 may prevent or mediate simultaneous use of resources. The resource manager 524 may store and manage whether a specific resource is in use, information for identifying which process is in use, and process information waiting to use a specific resource.

The systemd 525 is a system and service manager that may manage and control processes from system boot to shutdown. The systemd 525 initializes the system and manages the start, stop, and restart of various services (daemons). The systemd 525 may analyze dependencies between services and ensure that specific services run before other services when necessary. The systemd 525 may ensure that multiple services start in the correct order. The systemd 525 may define services, sockets, timers, etc. with unit files and manage the unit files.

The boost daemon 526 may perform CPU scheduling and/or CPU resource management. According to an example, the boost daemon 526 may include an App Status Listener 531, an Inheritance Booster 532, a Service Booster 533, a Generic Booster 534, a Netlink Handler 535, and a Booster Manager 536.

The app status listener 531 may receive an event (e.g., an application execution event) associated with the lifecycle of the application 502. The App Status Listener 531 may identify whether the app is in a visible state or not based on the app state. For example, the App Status Listener 531 may know that the first app is visible in case that a visibilityChange Event(visible) occurs in the first app.

The inheritance booster 532 may perform an operation for priority inheritance between processes having different priorities. For example, the inheritance booster 532 may request the booster manager 536 to set (or change) a scheduling policy for a low-priority process to inherit the priority of a high-priority process. The service booster 533 may manage CPU resource allocation of the service process 527. The Generic Booster 534 may optimize resource allocation of the service process 527. The Netlink Handler 535 may receive events associated with the lifecycle of the process. The Booster Manager 536 may set a CPU policy (or CPU scheduling method), control group allocation, resource allocation ratio determination, or CPU resource allocation priority.

The service process 527 may provide functions necessary for the operation of a service (or application). There may be one or more service processes 527.

The kernel 506 may manage hardware and provide services necessary for the platform 504. The kernel 506 may include Netlink 542, Cgroup 544, and RealTime Scheduling unit 546.

The Netlink 542 may provide events associated with the lifecycle of the process of the application 502 (e.g., process fork event, process execute event, or process exit event). The Cgroup 544 may provide a CPU resource distribution function. The real-time scheduling unit 546 may perform real-time scheduling that preempts CPU resources.

Operations associated with CPU scheduling of the application 502 may be performed through the boost daemon 526 and kernel 506 of FIG. 5.

For example, at the time when the process of the application 502 is forked, the netlink 542 of the kernel 506 may provide a process fork event to the boost daemon 526. The boost daemon 526 may receive the process fork event (or application creation event) through the netlink handler 535. According to an example, the process fork event may be an event associated with the creation of the process of the application 502. For example, the process fork event may be an event indicating a state where the application 502 is created, a process identifier (PID) of the process of the application 502 is allocated, and a main thread (or main task) is created. According to an example, a process execution event (or application execution/resumption event) that may be provided from the netlink 542 may be an event indicating the execution of the process of the application 502 (or execution/resumption of the application) that may occur after the process fork event. According to an example, a process termination event may be an event indicating the termination of the process of the application 502 that may occur after the process execution event.

The netlink handler 535 may receive the process fork event and provide information about the received process fork event to the service booster 533. The service booster 533 may receive information about the process fork event from the netlink handler 535 and forward the received information to the booster manager 536 for CPU resource allocation for the process of the application 502.

The booster manager 536 may set a CPU policy for the process of the application 502 and allocate CPU resources. The process of the application 502 may perform initialization based on the allocated CPU resources. According to an example, initialization may include preparation operations (or preliminary operations) that should be performed to execute the application 502. In case that initialization is complete, the process of the application 502 may call a boost library (libboost) (or resource allocation boosting release API (application programming interface)) to request boosting release from the boost daemon 526.

The app status listener 531 may receive an app execution/resumption event. According to an example, the app execution/resumption event may be an event requesting the application 502. The application 502 associated with the app execution/resumption event may be, e.g., an application providing other services that do not require communication with at least one external device (e.g., OTT application). According to an example, the app execution event may be received based on a control signal transmitted from a remote control device (e.g., remote control). The control signal transmitted from the remote control device may be, e.g., a control signal based on a user's key input on the remote control device.

The app status listener 531 may provide information indicating that an app execution/resumption event has been received to the booster manager 536. The booster manager 536 may determine that the application 502 associated with the app execution/resumption event is executed/resumed based on the received information. In case that the application 502 is executed/resumed, the booster manager 536 may recognize the application 502 as a foreground app. The generic booster 534 may allocate the highest CPU scheduling priority to a foreground app based on the visibility of the app. The generic booster 534 allocates CPU scheduling priority based on the visibility of the app first, but may selectively adjust the CPU scheduling priority between processes in case that resource contention occurs. For example, the generic booster 534 may temporarily set the CPU scheduling priority of process B to be equal to or higher than process A in order to quickly recover resources preempted by process B and allocate them to process A, in case that resource contention occurs between process A with the highest CPU scheduling priority as a foreground app and process B with a relatively low CPU scheduling priority. During the temporary period, process B may be allocated CPU resources and release resources. In case that the resource is recovered, the CPU scheduling priority of process B may return to the original level.

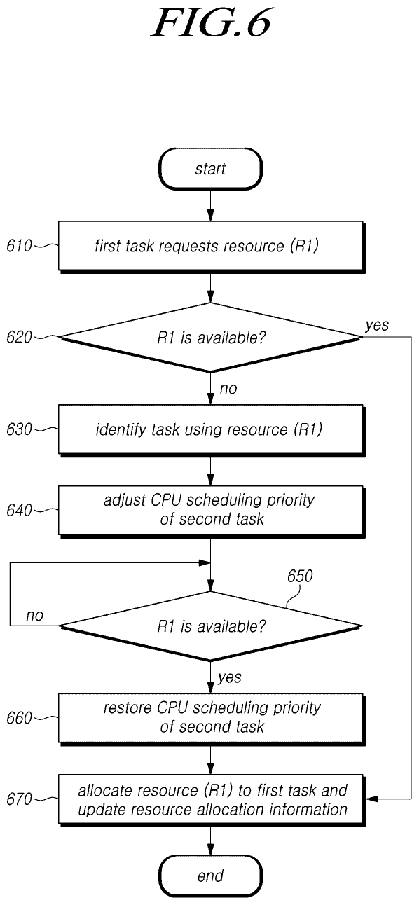

FIG. 6 is a flowchart illustrating an example selective CPU scheduling priority adjustment operation of a display device according to various embodiments.

A display device according to an embodiment may set a CPU scheduling priority according to the lifecycle of each process (e.g., foreground state) and selectively adjust the CPU scheduling priority in case that resource contention occurs. In the following embodiment, each operation may be performed sequentially, but is not necessarily performed sequentially. For example, the order of the operations may be changed, and at least two operations may be performed in parallel.

In operation 610, the display device according to an embodiment may receive a resource (R1) request from a first task. The display device may manage tasks to which CPU scheduling priority is applied on a process or thread basis. The first task may be, e.g., a process or thread. The resource (R1) may be a resource managed by a resource manager (e.g., the resource manager 524 of FIG. 5) and may be a hardware or software resource. The first task may be in a foreground state outputting a screen through the display and may have the highest CPU scheduling priority.

In operation 620, the display device according to an embodiment may determine whether the resource (R1) is available based on resource allocation information. The resource allocation information is a list of hardware/software resources in the display device and may be managed by the resource manager. The resource manager may manage registration, removal, use request, and release of a plurality of resources in the display device. For example, the resource manager may store and manage information about a task ID currently in use and a task ID waiting for use for each resource. The resource manager may set a CPU scheduling priority on a process or thread basis of the task requesting the resource.

The resource manager may return a null value in case that the resource (R1) is currently unused. The resource manager may return a task ID in use in case that the resource (R1) is currently in use. In the case that the resource (R1) is not currently in use, operation 670 may be performed.

In operation 630, when the resource manager indicates that the resource (R1) is not available, the display device according to an embodiment may identify a task using the resource (R1) based on a response (e.g., task ID) received from the resource manager about whether the resource (R1) is currently in use. The display device may identify that a second task is currently using the resource (R1) based on the task ID transmitted by the resource manager. The second task may have a CPU scheduling priority lower than the CPU scheduling priority of the first task and may be running in an invisible background state, for example.

In operation 640, the display device according to an embodiment may adjust the CPU scheduling priority of the second task currently using the resource (R1) to be high.

For example, in the display device, in case of switching from a second task (e.g., video meeting app) using a camera resource to a first task (e.g., health app), the first task is set with a high CPU scheduling priority, but in case that the second task holding the camera resource may not release (return) the camera resource, a phenomenon of waiting for the camera resource may occur. This represents a priority inversion phenomenon where the first task with a high CPU scheduling priority waits for resource release from the second task with a low CPU scheduling priority. Accordingly, the display device may temporarily set the CPU scheduling priority of the second task to be equal to or higher than the CPU scheduling priority of the first task for quick recovery of the resource (R1) to quickly resolve the CPU scheduling priority inversion phenomenon. The second task may be allocated CPU and release the resource (R1) while the CPU scheduling priority is adjusted. As a result, the first task in the foreground state may quickly use the resource (R1) without delay.

In case of adjusting the CPU scheduling priority of the second task, the display device may apply it on a thread basis. Alternatively, the display device may apply it on a process basis of the second task, and in case that the process includes multiple threads, it may adjust the CPU scheduling priority for all threads with dependencies.

In operation 650, the display device according to an embodiment may maintain the CPU scheduling priority of the second task until the resource (R1) is available, e.g., until the second task releases the resource (R1).

In operation 660, the display device according to an embodiment may restore the CPU scheduling priority of the second task to original. The CPU scheduling priority of the second task may return to the value before the CPU scheduling priority was adjusted by operation 640.

In operation 670, the display device according to an embodiment may allocate the resource (R1) to the first task and update the resource allocation information. The resource manager allocates the available resource (R1) to the first task that requested the resource, and may sequentially record the release by the second task and the use by the first task in the resource allocation information. The resource manager may update in real-time the available, in-use, or waiting state for each of the plurality of resources.

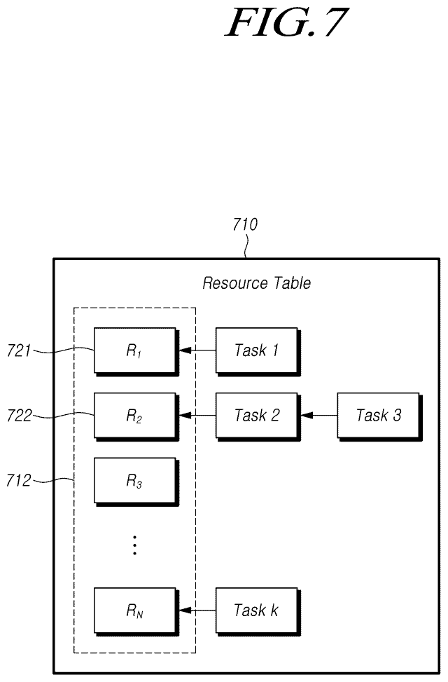

FIG. 7 is a diagram illustrating an example of resource allocation information in a display device according to various embodiments.

A display device according to an embodiment may include hardware resources connected to the display device or software resources stored in memory. The display device may store and manage resource allocation information (resource table) 710 to manage hardware/software resources.

Referring to FIG. 7, the resource allocation information 710 may include a plurality of resources 712. The plurality of resources 712 may include hardware/software resources, and Table 1 below is an example of a list of the plurality of resources 712.

TABLE 1

| enum | resource type | description |
|---|---|---|
| RM_CATEGORY_AUDIO_DECODER | Audio Decoder | |
| RM_CATEGORY_VIDEO_DECODER | Video Decoder | |
| RM_CATEGORY_VIDEO_DECODER_ | Video Decoder | For only Full |
| SUB | (Sub) | HD MFD |
| | | (Multi Format |
| | | Decoder) |
| RM_CATEGORY_DEMUX | Demux | |
| RM_CATEGORY_AUDIO_ENCODER | Audio Encoder | |
| RM_CATEGORY_VIDEO_ENCODER | Video Encoder | |
| RM_CATEGORY_SCALER | Scaler | |
| RM_CATEGORY_SCALER_SUB | Scaler (sub) | |
| RM_CATEGORY_TUNER | Tuner | |
| RM_CATEGORY_TUNER_SUB | Tuner (sub) | |
| RM_CATEGORY_AUDIO_MAIN_OUT | Audio Main | |
| | Output | |
| RM_CATEGORY_AUDIO_REMOTE_ | Audio Remote | |
| OUT | Output | |
| RM_CATEGORY_AUDIO_ | Audio Scart | |
| SCART_OUT | Output | |
| RM_CATEGORY_MM_PCM_OUT | MM PCM | |
| | Output | |
| RM_CATEGORY_AUDIO_DECODER_ | Audio Decoder | |
| SUB | (sub) | |
| RM_CATEGORY_JPEG_DECODER | JPEG decoder | |
| RM_CATEGORY_MJPEG_DECODER | MJPEG | |
| | decoder | |
| RM_CATEGORY_SW_DECODER | SW JPEG | |
| | decoder | |
| RM_CATEGORY_EXT_VIDEO_SRC | External Video | |
| | Source | |
| RM_CATEGORY_EXT_AUDIO_SRC | External Audio | |
| | Source | |
| RM_CATEGORY_EXT_HDMI_SRC | External HDMI | |
| | Source | |
| RM_CATEGORY_EXT_COMP_SRC | External | |
| | Component | |
| | Source | |
| RM_CATEGORY_EXT_AV_SRC | External AV | |
| | Source | |
| RM_CATEGORY_EXT_AUDIO_SRC_ | External Audio | LFD only |
| DVI | Source DVI | |
| RM_CATEGORY_EXT_AUDIO_SRC_ | External Audio | LFD only |
| HDMI | Source HDMI | |
| RM_CATEGORY_EXT_AUDIO_SRC_ | External Audio | LFD |
| DP | Source DP | only (Display |
| | | Port) |
| RM_CATEGORY_EXT_AUDIO_SRC_ | External Audio | LFD |
| SBB | Source SBB | only |
| | | (MagicInfo) |
| RM_CATEGORY_EXT_AUDIO_SRC_ | External Audio | LFD only |
| OPS | Source OPS | (PIM-Plug |
| | | In Module) |
| RM_CATEGORY_EXT_VIDEO_SRC_ | External Video | LFD only |
| DVI | Source DVI | |
| RM_CATEGORY_EXT_VIDEO_SRC_ | External Video | LFD only |
| HDMI | Source HDMI | |
| RM_CATEGORY_EXT_VIDEO_SRC_ | External Video | LFD only |
| DP | Source DP | (Display Port) |
| RM_CATEGORY_EXT_VIDEO_SRC_ | External Video | LFD only |
| SBB | Source SBB | (MagicInfo) |
| RM_CATEGORY_EXT_VIDEO_SRC_ | External Video | LFD only |
| OPS | Source OPS | (PIM-Plug |
| | | In Module) |
| RM_CATEGORY_EXT_PC_SRC | External | |
| | Source PC | |
| RM_CATEGORY_CAMERA | Camera | |
| RM_CATEGORY_MIC | MIC | |
| RM_CATEGORY_DEMUX_REC | Demux for | |
| | recording | |
| RM_CATEGORY_INPUT_SRC_DTV | Input Source | |
| | DTV | |
| RM_CATEGORY_INPUT_SRC_ATV | Input Source | |
| | ATV | |
| RM_CATEGORY_INPUT_SRC_HDMI | Input Source | |
| | HDMI | |
| RM_CATEGORY_INPUT_SRC_COMP | Input Source | |
| | Component | |
| RM_CATEGORY_INPUT_SRC_AV | Input Source | |
| | AV | |
| RM_CATEGORY_INPUT_SRC_ | Input Source | |

| | |
|---|---|
| SCART | Scart |

In Table 1, enum represents the enumeration type for the plurality of resources, and resource type represents the type of resource. The plurality of resources may include, e.g., an audio decoder, a video decoder, a demultiplexer (DEMUX), an audio encoder, a video encoder, a scaler, a tuner, an audio output, an audio remote output, an audio SCART output, a multimedia pulse code modulation (PCM) output, an image decoder, an external video source, an external HDMI source, an external component source, an external AV source, a camera, a microphone, or a demultiplexer for recording. The display device may record a task ID in case that a task using each resource is present through the resource manager (e.g., the resource manager 524 of FIG. 5). For example, it may be identified that the first resource (R₁) 721 is being used by task 1. It is recorded that the second resource (R₂) 722 is being used by task 2, and task 3 is waiting for use. The resource manager (e.g., the resource manager 524 of FIG. 5) may update the resource allocation information in real-time for resource requests and resource releases of tasks. The resource allocation information may be implemented in various forms and is not limited to the example of FIG. 7.

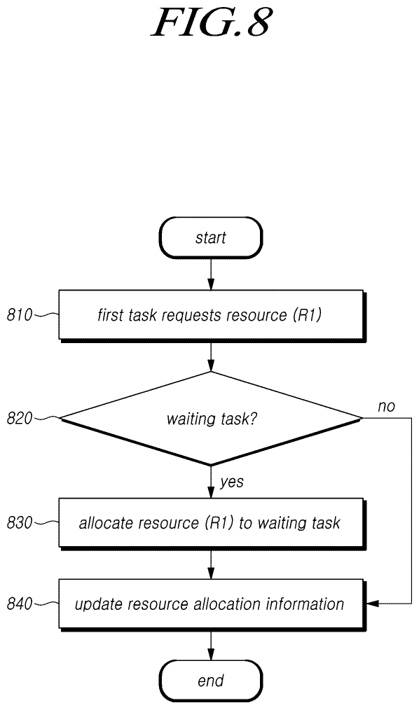

FIG. 8 is a flowchart illustrating an example resource release request operation of a display device according to various embodiments.

A display device according to an embodiment may update resource allocation information for the resource according to a task's resource release request. In the following embodiment, each operation may be performed sequentially, but is not necessarily performed sequentially. For example, the order of the operations may be changed, and at least two operations may be performed in parallel.

In operation 810, the display device according to an embodiment may receive a resource (R1) release request from a first task. The first task may be a running process or thread. The resource (R1) may be a hardware resource connected to the display device or a software resource stored in memory.

In operation 820, the display device according to an embodiment may identify whether there is a task waiting for the resource (R1). The resource manager (e.g., the resource manager 524 of FIG. 5) managing hardware/software resources available in the display device may identify whether there is a task wanting to use the resource (R1) in the resource allocation information according to the release request for the resource (R1).

In operation 830, in case that there is a task waiting for the resource (R1), the display device according to an embodiment may allocate the resource (R1) to that task.

In operation 840, the display device according to an embodiment may delete the first task for the resource (R1) in the resource allocation information through the resource manager and record the second task as the task in use (YES in operation 820). In case that there is no task waiting for the resource (R1), the resource manager may change the resource (R1) to an available state in the resource allocation information and delete the first task (NO in operation 820).

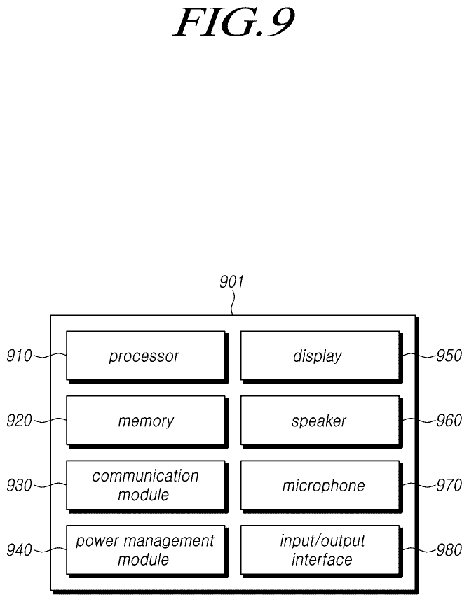

FIG. 9 is a block diagram illustrating an example configuration of a display device according to various embodiments.

A display device 901 according to an embodiment may include a processor (e.g., including processing circuitry) 910, a memory 920, a communication module (e.g., including communication circuitry) 930, a power management module (e.g., including power management circuitry) 940, a display 950, a speaker 960, a microphone 970, and an input/output interface (e.g., including various circuitry) 980. According to an example, the display device 901 may include additional components (e.g., a camera) other than the illustrated components, or may omit at least one of the illustrated components.

The processor 910 may include various processing circuitry and execute, for example, software (e.g., a program) to control at least one other component (e.g., a hardware or software component) of the display device 901 coupled with the processor 910, and may perform various data processing or computation. According to an embodiment, as at least part of the data processing or computation, the processor 910 may load a command or data received from another component (e.g., communication module 130) onto a volatile memory, process the command or the data stored in the volatile memory, and store resulting data in a non-volatile memory. According to an embodiment, the processor 910 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. Thus, the processor 910 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 920 may store various data used by at least one component (e.g., the processor 910 or the communication module 930) of the display device 901. The data may include, e.g., input data or output data for software (e.g., program) and related commands. The memory 920 may include volatile memory or nonvolatile memory.

The program may be stored, as software, in the memory 920 and may include, e.g., an operating system (OS), middleware, or an application. According to an example, the memory 920 may store various pieces of information or data related to an operation of the display device 901, and may store at least one program.

The communication module 930 may include various communication circuitry including, for example, a wireless communication module (e.g., a cellular communication module, a short-range wireless communication module, or a global navigation satellite system (GNSS) communication module) or a wired communication module (e.g., a local area network (LAN) communication module, or a power line communication module). A corresponding one of these communication modules may communicate with the external electronic device (e.g., a server) via a short-range communication network (e.g., Bluetooth, wireless-fidelity (Wi-Fi) direct, or infrared data association (IrDA)) or a long-range communication network (e.g., a legacy cellular network, a 5G network, a next-generation communication network, the Internet, or a computer network (e.g., LAN or WAN).

The wireless communication module may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module may support a high-frequency band (e.g., the mmWave band) to achieve, e.g., a high data transmission rate.

The power management module 940 may include various power management circuitry and provide power to the display device 901. In an embodiment, the power management module 940 may include a battery, a charging interface, and a power management integrated circuit (PMIC). The power management module 940 may be configured to supply power from the battery to the processor 910.

The display 940 may visually provide information to the outside (e.g., the user) of the display device 901. The display 950 may include, for example, and without limitation, a display, a hologram device, a projector, or the like, and control circuitry to control a corresponding one of the display, hologram device, and projector. According to an embodiment, the display 950 may include a touch sensor configured to detect a touch, or a pressure sensor configured to measure the intensity of a force generated by the touch.

A speaker 960 may output sound. In case of playing various contents provided by the display device 901, sound may be output through the speaker 960.

The microphone 970 is an input device sensor that detects sound and may provide a voice recognition function. The display device 901 may recognize a user voice through the microphone 970 and receive a user command.

The input/output interface 980 may include various circuitry and support one or more connecting terminals or protocols that may be used for the display device 901 to connect directly or wirelessly with an external electronic device. According to an embodiment, the input/output interface 980 may include, e.g., a high definition multi-media interface (HDMI), a universal serial bus (USB) interface, an SD card interface, or an audio interface.

The connecting terminal may include a connector through which the display device 901 may be physically connected to an external electronic device (e.g., resource device). According to an embodiment, the connecting terminal may include, for example, a HDMI connector, a USB connector, a SD card connector, or an audio connector (e.g., a headphone connector).

A display device 901 according to an example embodiment may include a display 950, a memory 920 including at least one storage medium storing instructions, and at least one processor 910 including a processing circuit.

According to an example embodiment, the display device 901 may, in response to a first resource request occurring from the first process while a first process outputs a screen through the display 950, identify whether the first resource is in use, and based on determining that the first resource is being used by a second process and that a CPU scheduling priority of the first process is higher than a CPU scheduling priority of the second process, adjust the CPU scheduling priority of the second process to be higher than or equal to the CPU scheduling priority of the first process, and in response to the first resource being released by the second process, restore the CPU scheduling priority of the second process to an original CPU scheduling priority.

According to an example embodiment, the display device 901 may allocate a highest CPU scheduling priority to a process in a foreground state, and the first process may be in a foreground state and the second process may be in a background state.

According to an example embodiment, the display device 901 may complete use of the first resource while the CPU scheduling priority of the second process is adjusted.

According to an example embodiment, the display device 901 may, in response to the first resource being released by the second process, allocate the first resource to the first process.

According to an example embodiment, the display device 901 may store information about a plurality of resources included in the display device 901, and manage registration, removal, use request, and release of each resource among the plurality of resources.

According to an example embodiment, the plurality of resources may include hardware resources connected to the display device 901 or software resources stored in the memory 920.

According to an example embodiment, the plurality of resources may include at least one of an audio decoder, a video decoder, a demultiplexer (DEMUX), an audio encoder, a video encoder, a scaler, a tuner, an audio output, an audio remote output, an audio SCART output, a multimedia pulse code modulation (PCM) output, an image decoder, an external video source, an external HDMI source, an external component source, an external AV source, a camera, a microphone, or a demultiplexer for recording.

According to an example embodiment, the display device 901 may, in response to receiving a use request or release for each resource among the plurality of resources on a process or thread basis, update in real-time an available, in-use, or waiting state for each resource.

According to an example embodiment, the display device 901 may, in response to a use request for each resource among the plurality of resources, record identification information of a process or thread, and in response to a process or thread releasing a resource, delete the identification information for each resource.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that in case that an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. In case of being distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A display device, comprising:
a display;
memory including at least one storage medium storing instructions; and
at least one processor, comprising processing circuitry,
wherein at least one processor, individually and/or collectively is configured to execute the instructions and to cause the display device to:
in response to a first resource request occurring from a first process while the first process outputs a screen through the display, identify whether the first resource is in use;
based on determining that the first resource is in use by a second process and that a CPU scheduling priority of the first process is higher than a CPU scheduling priority of the second process, adjust the CPU scheduling priority of the second process to be higher than or equal to the CPU scheduling priority of the first process; and
in response to the first resource being released by the second process, restore the CPU scheduling priority of the second process to an original CPU scheduling priority.

2. The display device of claim 1, wherein at least one processor, individually and/or collectively, is configured to cause the display device to allocate a highest CPU scheduling priority to a process in a foreground state, and wherein the first process is in the foreground state and the second process is in a background state.

3. The display device of claim 1, wherein at least one processor, individually and/or collectively, is configured to cause the display device to complete use of the first resource while the CPU scheduling priority of the second process is adjusted.

4. The display device of claim 1, wherein at least one processor, individually and/or collectively, is configured to cause the display device to, in response to the first resource being released by the second process, allocate the first resource to the first process.

5. The display device of claim 1, wherein at least one processor, individually and/or collectively, is configured to cause the display device to:
store information about a plurality of resources included in the display device; and
manage registration, removal, use request, and release of each resource among the plurality of resources.

6. The display device of claim 5, wherein the plurality of resources includes hardware resources connected to the display device or software resources stored in the memory.

7. The display device of claim 5, wherein the plurality of resources include at least one of: an audio decoder, a video decoder, a demultiplexer, an audio encoder, a video encoder, a scaler, a tuner, an audio output, an audio remote output, an audio SCART output, a multimedia pulse code modulation (PCM) output, an image decoder, an external video source, an external HDMI source, an external component source, an external AV source, a camera, a microphone, or a demultiplexer for recording.

8. The display device of claim 5, wherein at least one processor, individually and/or collectively, is configured to cause the display device to, in response to receiving a use request or release for each resource among the plurality of resources on a process or thread basis, update in real-time an available, in-use, or waiting state for each resource.

9. The display device of claim 8, wherein at least one processor, individually and/or collectively, is configured to cause the display device to:
in response to a use request for each resource among the plurality of resources, record identification information of a process or thread; and
in response to a process or thread releasing a resource, delete the identification information for each resource.

10. A method of operating a display device, the method comprising:
in response to a first resource request occurring from a first process while the first process outputs a screen through a display, identifying whether the first resource is in use;
based on determining that the first resource is in use by a second process and that a CPU scheduling priority of the first process is higher than a CPU scheduling priority of the second process, adjusting the CPU scheduling priority of the second process to be higher than or equal to the CPU scheduling priority of the first process; and
in response to the first resource being released by the second process, restoring the CPU scheduling priority of the second process to an original CPU scheduling priority.

11. The method of claim 10, wherein the first process is in the foreground state and the second process is in a background state, and wherein the method further comprises allocating a highest CPU scheduling priority to a process in the foreground state.

12. The method of claim 10, further comprising causing the second process to complete use of the first resource while the CPU scheduling priority of the second process is adjusted.

13. The method of claim 10, further comprising, in response to the first resource being released by the second process, allocating the first resource to the first process.

14. The method of claim 10, further comprising:
storing information about a plurality of resources included in the display device; and
managing registration, removal, use request and release of each resource among the plurality of resources.

15. The method of claim 14, wherein the plurality of resources include hardware resources connected to the display device or software resources stored in a memory included in the display device.

16. The method of claim 14, wherein the plurality of resources include at least one of: an audio decoder, a video decoder, a demultiplexer, an audio encoder, a video encoder, a scaler, a tuner, an audio output, an audio remote output, an audio SCART output, a multimedia pulse code modulation (PCM) output, an image decoder, an external video source, an external HDMI source, an external component source, an external AV source, a camera, a microphone, or a demultiplexer for recording.

17. The method of claim 14, further comprising, in response to receiving a use request or release for each resource among the plurality of resources on a process or thread basis, updating in real-time an available, in-use, or waiting state for each resource.

18. The method of claim 14, further comprising:
in response to a use request for each resource among the plurality of resources, recording identification information of a process or thread; and
in response to a process or thread releasing each resource, deleting the identification information for each resource.

19. A non-transitory computer-readable storage medium storing at least one computer-readable instruction, wherein the at least one instruction, when executed by at least one processor, comprising processing circuitry, of an electronic device, individually and/or collectively, causes the electronic device to:
in response to a first resource request occurring from a first process while the first process outputs a screen through a display, identify whether the first resource is in use;
based on determining that the first resource is in use by a second process and that a CPU scheduling priority of the first process is higher than a CPU scheduling priority of the second process, adjust the CPU scheduling priority of the second process to be higher than or equal to the CPU scheduling priority of the first process; and
in response to the first resource being released by the second process, restore the CPU scheduling priority of the second process to an original CPU scheduling priority.

20. The non-transitory computer-readable storage medium of claim 19, wherein the at least one instruction, when executed by at least one processor, comprising processing circuitry, of an electronic device, individually and/or collectively, further causes the electronic device to, in response to the first resource being released by the second process, allocating the first resource to the first process.
